(19) United States
(12) Patent Application Publication
(10) Pub. No.: US 2026/0182581 A1
(43) Pub. Date: Jul. 2, 2026

(54) ANTIBACTERIAL MATERIAL BASED ON ZEIN-VANILLIN COMPLEX AND PREPARATION METHOD THEREOF

(71) Applicant: Jilin Agricultural University, Changchun (CN)

(72) Inventors: Hao Zhang, Changchun (CN); Tiantong Lan, Changchun (CN); Jin Gu, Changchun (CN); Jingsheng Liu, Changchun (CN)

(21) Appl. No.: 19/007,882

(22) Filed: Jan. 2, 2025

(51) Int. Cl. A01N 59/16; A01N 25/08; A01P 1/00

(52) U.S. Cl. CPC A01N 59/16; A01N 25/08; A01P 1/00

(57) ABSTRACT

An antibacterial material based on a zein-vanillin complex and a preparation method thereof, belonging to the technical field of antibacterial material preparation. The preparation method of the antibacterial material based on the zein-vanillin complex comprises the following steps: dissolving zein in ethanol or water to obtain a protein solution; subjecting the protein solution to ultrasonic treatment to obtain a modified protein solution; mixing the modified protein solution with vanillin for a first mixing to obtain a zein-vanillin complex; mixing the zein-vanillin complex with a silver nitrate solution for a second mixing to obtain the antibacterial material based on the zein-vanillin complex. The antibacterial material of the invention first obtains the zein-vanillin complex, and then mixes it with silver nitrate, so that the nano-silver is combined with the organic complex, which has higher biocompatibility during sterilization, resulting in higher antibacterial effect.

### 1. TECHNICAL FIELD

The invention relates to the technical field of antibacterial material preparation, in particular to an antibacterial material based on a zein-vanillin complex and a preparation method thereof.

### 2. BACKGROUND ART

Antibacterial materials, as a type of new functional material with the ability to kill or inhibit microorganisms, are playing an increasingly important role in various fields. Antibacterial materials refer to those materials that possess the ability to kill or inhibit microorganisms (such as bacteria, viruses, etc.). According to the different antibacterial mechanisms, antibacterial materials can be classified into: nano antibacterial materials: these materials achieve efficient antibacterial performance through mechanisms such as the release of antibacterial ions, generation of oxidative stress responses, or direct damage to microbial cell structures. Organic antibacterial materials: taking quaternary ammonium salt-based antibacterial agents as an example, these materials have positively charged nitrogen (N) that attracts bacteria, damages the cell wall structure, and causes the leakage of bacterial contents; the antibacterial mechanism is classified as “contact-killing”. Natural antibacterial materials: an example is chitosan, an active substance with a positive charge; its antibacterial mechanism may be that under acidic conditions, the amino cations of chitosan adsorb negatively charged bacteria, restricting the freedom of microorganisms and hindering their metabolism and reproduction. Polymeric antibacterial materials: an example is polymeric quaternary ammonium salts; the N+ on the antibacterial group interacts with the negative charge on the bacterial surface, attaching to the bacterial surface; it acts like an “anion sponge”, absorbing some anionic bacterial cell membranes into its internal gaps, causing the microbial membrane to wrinkle and deform, leading to leakage of intracellular substances and ultimately killing the bacteria. With the improvement of people's health awareness and the increasing demand for antibacterial materials, traditional antibacterial agents have been unable to meet the needs of modern society in some aspects.

Nano-silver, as a novel antibacterial material, has garnered increasing attention and favor due to its advantages such as broad-spectrum antibacterial activity, no drug resistance, strong penetration, and high safety. In particular, nano-silver antibacterial materials are increasingly being applied in various fields including healthcare, personal care, household textiles, food packaging, and water treatment.

Nano-silver technology refers to the process of utilizing special techniques to reduce silver elemental particles to a nanoscale size, thereby endowing them with unique optical properties, catalytic properties, and antibacterial properties. The particle size of nano-silver is generally around 25 nanometers or even smaller, which significantly increases the surface area and subsequently enhances the antibacterial performance. With the continuous development of nanotechnology, the preparation processes for nano-silver have become increasingly mature, leading to significant improvements in both yield and quality; this has provided a solid technical foundation for its application in the antibacterial field. However, the compatibility of nano-silver with bacterial cells when used alone needs further enhancement.

Vanillin, chemically known as 3-methoxy-4-hydroxybenzaldehyde, appears as white needle-shaped crystals. It is not easily volatile at higher temperatures and tends to discolor when it encounters alkaline substances. Due to the presence of a reducing aldehyde group in its chemical structure, vanillin exhibits antioxidant properties. The phenolic groups in vanillin are hydrophobic, and at lower pH values, they demonstrate even stronger hydrophobicity, which is one of the reasons for its good antibacterial activity. As a compound extracted from natural plants, vanillin's safety is widely recognized, making it suitable for use in antibacterial and preservative food packaging or medical packaging materials.

Since small molecular organic compounds have poor stability in the environment, they can improve the defects of small molecular organic compounds after combining with protein, and the stability of the complex is stronger, which helps to better exert the functionality of small molecular organic compounds. Among the current proteins, zein is a high-quality plant protein produced from corn as raw material; it has a wide range of sources and contains nearly 20 types of amino acids, including 8 essential amino acids for the human body, and is rich in nutrition.

However, the interaction between proteins and small molecular organic compounds can be classified into two main types: non-covalent interactions and covalent interactions. Most non-covalent interactions are driven by hydrogen bonds, hydrophobic interactions, electrostatic interactions, and van der Waals forces, and these interactions are typically reversible. In contrast, covalent interactions involve bonding through covalent bonds and are usually irreversible. In the process of protein-small molecular organic compound interactions, non-covalent binding may coexist with covalent binding. Both types of interactions can induce protein structural changes, such as aggregation or unfolding, which in turn can alter its physicochemical properties, functional characteristics, and nutritional value. Additionally, when used as antibacterial materials, their antibacterial performance tends to be poor. A current challenge is how to balance the interaction between proteins and small molecular organic compounds to better enhance the functionality of the small molecular organic compounds, as well as how to improve the antibacterial properties of the resulting material after binding.

Based on this, it is of great practical significance to provide an antibacterial material based on a zein-vanillin complex.

### 3. SUMMARY OF THE INVENTION

The object of the invention is to provide an antibacterial material based on a zein-vanillin complex and a preparation method thereof, aiming to solve the technical problem of poor antibacterial performance of protein-organic small molecule combined materials in the prior art.

In order to realize the object of the invention, the invention provides the following technical scheme:
a preparation method of an antibacterial material based on a zein-vanillin complex, comprising the following steps:
dissolving zein in ethanol or water to obtain a protein solution;
subjecting the protein solution to ultrasonic treatment to obtain a modified protein solution;
mixing the modified protein solution with vanillin for a first mixing to obtain a zein-vanillin complex;
mixing the zein-vanillin complex with a silver nitrate solution for a second mixing to obtain the antibacterial material based on the zein-vanillin complex.

Further, the mass concentration of the protein solution is 6-10 mg/mL.

Further, the power of the ultrasonic treatment is 240-480 kw, and the time is 30-40 minutes.

Further, the ratio of the modified protein solution to vanillin used in the first mixing is 25-40: 1-2.

Further, the temperature of the first mixing is 20-25° C. and the time is 2-4 hours.

Further, the ratio of the zein-vanillin complex to the silver nitrate solution used in the second mixing is 2-3: 1-2.

Further, the concentration of the silver nitrate solution is 15-20 mg/mL.

Further, the temperature of the second mixing is 50-60° C., and the time is 1-2 hours.

The invention also provides the antibacterial material, wherein the antibacterial material is obtained through the preparation method of the antibacterial material based on the zein-vanillin complex of the technical scheme.

Compared with the prior art, the technical scheme of the invention has the following advantageous effects:
(1) the invention improves the protein structure in the zein solution by ultrasound treatment; the ultrasound causes the complex structure of the protein to unfold, with the coiled structure becoming looser; at the same time, the extent of protein structure unfolding is influenced differently by various ultrasonic treatment parameters, meaning the internal structure undergoes changes to varying degrees depending on the parameters; moreover, the changes in the protein's internal structure are not solely dependent on a single variation in the ultrasonic parameters; by limiting the ultrasonic treatment parameters, the invention gradually disrupts the internal ordered structure of zein, reducing the degree of molecular aggregation and transforming larger molecular particles into smaller ones, making the internal structure of zein more loose and uniform; when mixed with vanillin, it serves as a uniform loading substrate to carry the vanillin, forming a zein-vanillin complex;
(2) the particle size of silver nanoparticles in silver nitrate varies with its concentration, and this variation in particle size further influences their specific surface area. Changes in the specific surface area directly affect their antibacterial capability. The invention combines the zein-vanillin complex with silver nitrate, and by controlling the concentration of silver nitrate, it achieves silver nanoparticles with a large specific surface area and thus a higher antibacterial effect. The initially prepared organic complex of the invention, the zein-vanillin complex, when combined with nano-silver, enhances the biocompatibility and biodegradability of the nano-silver; this allows it to more rapidly enter the interior of bacteria, combine with the oxygen metabolism enzymes (—SH) of the bacteria, and inactivate these enzymes, thereby blocking the respiratory metabolism of the bacteria and causing them to suffocate and die; additionally, nano-silver can also inhibit the synthesis of bacterial proteins, inactivate bacterial proteases and nucleases, and thereby prevent the replication and growth of the bacteria, achieving an antibacterial effect. The new antibacterial material formed has higher antibacterial properties and can be used in food packaging or medical packaging materials.

### 4. BRIEF DESCRIPTION OF ACCOMPANY DRAWINGS

FIG. 1 is a flow chart of a preparation method of an antibacterial material based on a zein-vanillin complex of the invention.

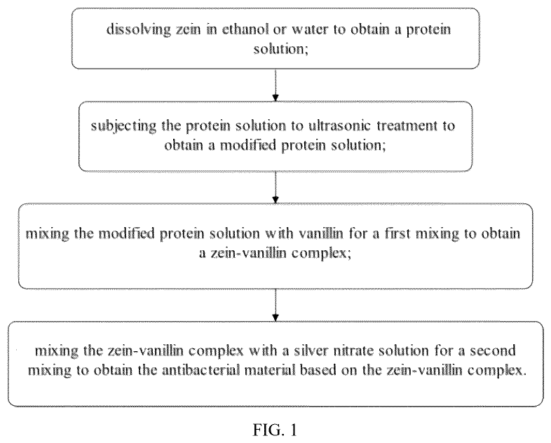

### 5. SPECIFIC EMBODIMENT OF THE INVENTION

The invention provides a preparation method of an antibacterial material based on a zein-vanillin complex, comprising the following steps:
dissolving zein in ethanol or water to obtain a protein solution;
subjecting the protein solution to ultrasonic treatment to obtain a modified protein solution;
mixing the modified protein solution with vanillin for a first mixing to obtain a zein-vanillin complex;
mixing the zein-vanillin complex with a silver nitrate solution for a second mixing to obtain the antibacterial material based on the zein-vanillin complex.
dissolving zein in ethanol or water to obtain a protein solution;

The invention first dissolves zein in ethanol or water at room temperature.

In the invention, the mass concentration of the protein solution is preferably 6-10 mg/mL, and more preferably 6-8 mg/mL.

Subjecting the protein solution to ultrasonic treatment to obtain a modified protein solution;
the invention improves the protein structure in the zein solution by ultrasound treatment; the ultrasound causes the complex structure of the protein to unfold, with the coiled structure becoming looser; at the same time, the degree of structural improvement varies with the change in ultrasonic power. The invention specifically limits the ultrasonic power, making the internal structure of the zein loose, and converting large particles into small ones, which are not only loose but also uniform, facilitating subsequent binding with vanillin.

In the invention, the power of the ultrasonic treatment is preferably 240-480 kW, further preferably 240-360 kW, and more preferably 240-300 kW; the time is preferably 30-40 minutes, further preferably 30-35 minutes, and more preferably 30-33 minutes.

The extent of protein structure unfolding is influenced differently by various ultrasonic treatment parameters, meaning the internal structure undergoes changes to varying degrees depending on the parameters; moreover, the changes in the protein's internal structure are not solely dependent on a single variation in the ultrasonic parameters. By limiting the ultrasonic treatment parameters, the invention allows for better loading of vanillin onto the zein, maximizing the functionality of vanillin.

Mixing the modified protein solution with vanillin for a first mixing to obtain a zein-vanillin complex;
after mixing the protein solution that has undergone ultrasonic treatment with vanillin, they combine at a specific temperature to form a complex, achieving encapsulation and loading of vanillin; this process enables the small organic molecule vanillin to better exhibit its functionality while also facilitating further compounding with nano-silver to obtain an antibacterial material.

In the invention, the ratio of the modified protein solution to vanillin used in the first mixing is preferably 25-40: 1-2, further preferably, 25-30: 1, and more preferably, 25:1.

In the invention, the temperature of the first mixing is preferably 20-25° C., further preferably, 20-23° C., the time is preferably 2-4 h, and further preferably, 2-3 h.

Mixing the zein-vanillin complex with a silver nitrate solution for a second mixing to obtain the antibacterial material based on the zein-vanillin complex.

The particle size of silver nanoparticles in silver nitrate varies with its concentration, and this variation in particle size further influences their specific surface area. Changes in the specific surface area directly affect their antibacterial capability. The invention combines the zein-vanillin complex with silver nitrate, and by controlling the concentration of silver nitrate, it achieves silver nanoparticles with a large specific surface area and thus a higher antibacterial effect. The initially prepared organic complex of the invention, the zein-vanillin complex, when combined with nano-silver, enhances the biocompatibility and biodegradability of the nano-silver; this allows it to more rapidly enter the interior of bacteria, combine with the oxygen metabolism enzymes (—SH) of the bacteria, and inactivate these enzymes, thereby blocking the respiratory metabolism of the bacteria and causing them to suffocate and die; additionally, nano-silver can also inhibit the synthesis of bacterial proteins, inactivate bacterial proteases and nucleases, and thereby prevent the replication and growth of the bacteria, achieving an antibacterial effect.

In the invention, the ratio of the zein-vanillin complex to the silver nitrate solution used in the second mixing is preferably 2-3: 1-2, further preferably, 1:1.

In the invention, the concentration of the silver nitrate solution is preferably 15-20 mg/mL, further preferably, 15-18 mg/mL, more preferably, 15 mg/mL.

In the invention, the temperature of the second mixing is preferably 50-60° C., further preferably, 50-55° C.; and the time is preferably 1-2 h, further preferably, 1-1.5 h.

When nano-silver is combined with the corn zein-vanillin organic complex, both the mixing ratio and the mixing temperature must be considered. The organic complex exhibits different activities at different temperatures, which in turn leads to varying degrees of binding with nano-silver. By limiting the binding temperature, This invention not only preserves the activity of the organic complex, but also enhances the binding rate between the organic complex and nano-silver, bringing in a final antibacterial material with superior antibacterial performance.

The invention also provides the antibacterial material, wherein the antibacterial material is obtained through the preparation method of the antibacterial material based on the zein-vanillin complex of the technical scheme.

Further, when the antibacterial material obtained by the preparation method of the invention is used as the main component to prepare antibacterial or similar materials with the same effects, it also falls within the protection scope of the invention without departing from the inventive principle of the invention.

In the invention, unless otherwise specified, the raw materials required for preparation are all commercially available products well known to those skilled in the art; in addition, the invention does not specifically limit the operations such as mixing and stirring, and the technical means and parameters well known to those skilled in the art can be used according to the actual situation.

The technical scheme provided by the invention are described in detail below in combination with the embodiments, but they should not be construed as limiting the protection scope of the invention.

### Embodiment 1

(1) dissolving zein in water at room temperature to obtain a 6 mg/mL protein solution;
(2) subjecting the protein solution to ultrasonic treatment at a power of 240 kW for 30 minutes to obtain a modified protein solution;
(3) mixing and stirring the modified protein solution with vanillin at a mass ratio of 25: 1 at a temperature of 20° C. for 2 hours obtain a zein-vanillin complex;
(4) stirring the zein-vanillin complex with a silver nitrate solution with a mass concentration of 15 mg/mL at a ratio of 2:1 at 50° C., stirring evenly for 1 hour to obtain an antibacterial material based on the zein-vanillin complex.

### Embodiment 2

(1) dissolving zein in ethanol at room temperature to obtain a 8 mg/mL protein solution;
(2) subjecting the protein solution to ultrasonic treatment at a power of 360 kW for 35 minutes to obtain a modified protein solution;
(3) mixing and stirring the modified protein solution with vanillin at a mass ratio of 25: 2 at a temperature of 23° C. for 2 hours obtain a zein-vanillin complex;
(4) stirring the zein-vanillin complex with a silver nitrate solution with a mass concentration of 18 mg/mL at a ratio of 3:2 at 55° C., stirring evenly for 1.5 hours to obtain an antibacterial material based on the zein-vanillin complex.

### Embodiment 3

(1) dissolving zein in water at room temperature to obtain a 10 mg/mL protein solution;
(2) subjecting the protein solution to ultrasonic treatment at a power of 480 kW for 40 minutes to obtain a modified protein solution;
(3) mixing and stirring the modified protein solution with vanillin at a mass ratio of 20: 1 at a temperature of 25° C. for 2 hours obtain a zein-vanillin complex;
(4) stirring the zein-vanillin complex with a silver nitrate solution with a mass concentration of 20 mg/mL at a ratio of 1:1 at 60° C., stirring evenly for 2 hours to obtain an antibacterial material based on the zein-vanillin complex.

### Embodiment 4

(1) dissolving zein in ethanol at room temperature to obtain a 10 mg/mL protein solution;
(2) subjecting the protein solution to ultrasonic treatment at a power of 300 kW for 33 minutes to obtain a modified protein solution;
(3) mixing and stirring the modified protein solution with vanillin at a mass ratio of 30: 1 at a temperature of 25° C. for 2 hours obtain a zein-vanillin complex;
(4) stirring the zein-vanillin complex with a silver nitrate solution with a mass concentration of 20 mg/mL at a ratio of 1:1 at 60° C., stirring evenly for 2 hours to obtain an antibacterial material based on the zein-vanillin complex.

### Embodiment 5

(1) dissolving zein in water at room temperature to obtain a 6 mg/mL protein solution;
(2) subjecting the protein solution to ultrasonic treatment at a power of 300 kW for 33 minutes to obtain a modified protein solution;
(3) mixing and stirring the modified protein solution with vanillin at a mass ratio of 30: 1 at a temperature of 25° C. for 2 hours obtain a zein-vanillin complex;
(4) stirring the zein-vanillin complex with a silver nitrate solution with a mass concentration of 20 mg/mL at a ratio of 2:1 at 50° C., stirring evenly for 2 hours to obtain an antibacterial material based on the zein-vanillin complex.

The above are only some preferred embodiments of the invention. It should be noted that, for ordinary technicians in this art, several improvements and modifications can be made without departing from the principle of the invention, and these improvements and modifications should also be regarded as the protection scope of the invention.

1. A preparation method of an antibacterial material based on a zein-vanillin complex, comprising the following steps:
dissolving zein in ethanol or water to obtain a protein solution;
subjecting the protein solution to ultrasonic treatment to obtain a modified protein solution;
mixing the modified protein solution with vanillin for a first mixing to obtain a zein-vanillin complex;
mixing the zein-vanillin complex with a silver nitrate solution for a second mixing to obtain the antibacterial material based on the zein-vanillin complex.

2. The preparation method of the antibacterial material based on the zein-vanillin complex of claim 1, wherein the mass concentration of the protein solution is 6-10 mg/mL.

3. The preparation method of the antibacterial material based on the zein-vanillin complex of claim 1, wherein the power of the ultrasonic treatment is 240-480 kw, and the time is 30-40 minutes.

4. The preparation method of the antibacterial material based on the zein-vanillin complex of claim 1, wherein the ratio of the modified protein solution to vanillin used in the first mixing is 25-40: 1-2.

5. The preparation method of the antibacterial material based on the zein-vanillin complex of claim 1, wherein the temperature of the first mixing is 20-25° C. and the time is 2-4 hours.

6. The preparation method of the antibacterial material based on the zein-vanillin complex of claim 1, wherein the ratio of the zein-vanillin complex to the silver nitrate solution used in the second mixing is 2-3: 1-2.

7. The preparation method of the antibacterial material based on the zein-vanillin complex of claim 1, wherein the concentration of the silver nitrate solution is 15-20 mg/mL.

8. The preparation method of the antibacterial material based on the zein-vanillin complex of claim 1, wherein the temperature of the second mixing is 50-60° C., and the time is 1-2 hours.

9. The antibacterial material, obtained through the preparation method of the antibacterial material based on the zein-vanillin complex of claim 1.
